(19) United States
(12) Patent Application Publication
(10) Pub. No.: US 2006/0175527 A1
(43) Pub. Date: Aug. 10, 2006

(54) Dessert log mold with formed cavity center

(76) Inventor: Fletcher Morgan, St. Peterbursg, FL (US)

Correspondence Address: JOHN S. HALE;GIPPLE & HALE, 6665-A OLD DOMINION DRIVE, MCLEAN, VA, 22101, US

(21) Appl. No.: 11/053,839

(22) Filed: Feb. 10, 2005

(51) Int. Cl. B29C 33/22

(52) U.S. Cl. 249/139

(57) ABSTRACT

A cooking pan assembly for forming a compound log shaped dessert having a central longitudinal cavity constructed with a semi-cylindrical circular base pan defining a cavity. A planar flange extends outward from the sidewalls of the base pan to support a cover member which is mounted to the base pan. The cover member is mounted on end a sleeve mounted on one end of the base pan and defines a plurality of apertures therein. An insert member with circular end sections connected by a longitudinal section having a designated cross section configuration is mounted in the cavity of the cooking pan assembly so that cake baked in the pan assembly is formed with a center cavity having a specific decorative shape.

### CROSS-REFERENCE TO RELATED APPLICATIONS

There are no related applications.

### TECHNICAL FIELD OF THE INVENTION

The present invention relates generally to the field of cake baking and dessert molds. More particularly, the present invention concerns an apparatus for baking a log type cake or molded dessert having a shaped longitudinal cavity formed therein by a base pan and an insert member which is mounted in the cavity of the base pan.

The present invention is thus directed toward an apparatus for molding cake batter, ice creams, gelatins or other desserts into an outer cylindrical log shape with an inner separate shaped cavity running along the central longitudinal axis of the cylindrical log. The invention also includes a plurality of shaped central insert members having different cross sectional shapes such as a heart, star or circle.

### BACKGROUND OF THE INVENTION

Food molds have been used and are well known in the prior art. Historically, it was known in the prior art to bake bread bowls which were semi-spherical loaves of bread into which a cavity was carved for placement of salads or soups. A conventional bread bowl is typically made by forming raw bread dough on the top of a simple inverted bowl which is then placed into the oven for baking. A common baking pan is a food mold, with an open end, a closed end and a peripheral side wall. The closed end and side wall define a hollow volume that becomes the three-dimensional shape of a food product molded by the baking pan.

Some food molds have a centrally located indentation at the closed end. With a mold of this type, a first food composition may be placed and formed in the pan assembly and a second food composition may be placed in the shaped central aperture formed by removal of the central insert. This provides an accurate fit for the second filler food composition within the first surrounding food composition.

Other food pans, such as a baking pan for making angel food cake, have an annular ring shaped with an open end. The hollow volume of the ring is filled with a food composition and then baked. After baking, the pan is inverted to remove the shaped food composition from the open end. Thus, the open end is used to form the bottom of the final food product.

In all baking pans, it is desirable to facilitate the partial escape of moisture from the pans in order to develop a degree of porosity in the final baked product. At the same time, however, the batter must absorb some moisture to prevent excessive dehydration. It therefore becomes necessary to contain the batter at a pressure sufficient to limit the extent to which water is converted to steam, since the batter absorbs steam less easily than water, while allowing for a degree of conversion and escape. The batter must also be contained to prevent the escape of the cake itself due to its expansion during baking.

It can thus be seen that a number of devices have been used in the molding and baking of desserts to obtain molded desserts in a variety of shaped configurations as described in the prior art. However, dual composition desserts with a separate centrally located composition are rare because of the complexity in preparing same.

Many prior art devices and techniques mold and bake dough of breads, batters of cakes, cookies, and other baked goods into various shapes including containers which may be used to hold other foods. For example, U.S. Pat. No. 4,812,323, issued Mar. 14, 1989, discloses a method for molding and baking cookie dough into a cup shape which can then be used to hold ice cream or other fillings in a similar manner to U.S. Pat. No. 3,296,956, issued Jan. 10, 1967, which also discloses a molding and baking apparatus for the baking of bread dough into a cup-like shape.

In U.S. Pat. No. 3,141,400 issued Jul. 21, 1964 a telescoping cake apparatus is disclosed with a center cone assembly which moves upward when the cake batter is baked forming a frustrum conical cake with a conical center cavity. A one piece strip cross link handle is secured to the upper edge of top of the expendable baking section and the cone by staples or the like.

U.S. Pat. No. 1,487,906 issued Mar. 25, 1924 is directed toward two nesting rectangular baking pans, the inner pan having flange members adapted to sit on a shelf formed in the outer pan with the composite unit being held in place by a strip of sheet metal which engages an upwardly extending flange of the outer pan.

A baked layered product with an apparatus for making same is shown in U.S. Pat. No. 3,831,507, issued Aug. 27, 1974. This baking assembly uses three baking pans to form a cylindrical bunt bowl body and lid which is placed over the body to hold the filling therein.

Similarly U.S. Pat. No. 1,852,966 issued Apr. 5, 1932 is directed toward a baking pan used for baking a cake with a hollow center so that the same can have a filling placed therein. A tapered tubular outer member has a core mold mounted thereon attached to a cover over the top of the tubular outer member.

U.S. Pat. No. 5,948,313, issued Sep. 7, 1999 is directed toward a mold assembly for making a baked edible shell. The mold assembly is constructed of an outer mold shell and an associated inner mold shell, the outer mold shell having a curved main portion with a central opening and an outer rim extending in a plane. The inner mold shell has a curved main portion with a central chimney shaped to pass through the outer mold central opening. The outer mold opening comprises a raised circular rim with an inwardly directed flange. The outer edge of the outer mold shell is formed with a rolled-up rim.

Another reference, U.S. Pat. No. 5,226,352 issued Jul. 13, 1993 is directed toward a baking assembly which has an outer dome shaped member and an inner dome shaped member as shown in FIGS. 6 and 7. A flange extends outward from the upper edge of the outer dome member to seat the flange extending from the upper edge of the inner dome member. The flanges are held together by a C clamp or other fastening means. The inner dome shaped member is TEFLON® coated on its inside surface and outside surface allowing cake or dough to be baked in the outer dome mold and the inner mold.

U.S. Pat. No. 5,528,981 issued Jun. 25, 1996 is directed toward a baking mold for sandwich rolls having an interior sandwich component cavity constructed of a retaining member and a form member. The retaining member is of a generally hollow cylindrical shape having a closed end and a circumferential side wall extending from the closed end to form a generally open end opposite the closed end. The form member includes a cylindrical slug portion, a spacer rail and a support portion. In use the retaining member is partially filled with an appropriate dough mixture, the form member is inserted in the retaining member and the dough is allowed to rise at which time the entire assembly is then placed in an oven for baking. When baking is complete, the form member is extracted from the retaining member along with the baked roll. Extraction of the form member from the retaining member is facilitated by the use of an appropriate non-stick coating which may be applied to both the retaining member and the form member. The spacer rail positions the slug in proper spaced alignment within the retaining member and also provides a slot in the roll produced in the mold. Thus the mold serves to produce a generally cylindrical shaped sandwich roll which has a cylindrical interior cavity formed by the slug.

It has been found desirable to mold or form desserts or cake into a cylindrical log shape which can be baked and/or frozen and marketed as a specialized cake having a central longitudinal cavity running the length of the cake with a different component from the outer log shape.

### SUMMARY OF TH INVENTION

The present invention is directed toward an assembly for producing a dual composition cylindrical dessert or cake using a semicircular base pan having a semicircular cover member removably mounted to the base pan. A central cavity producing insert member having a specific configured cross section is mounted within the cavity formed by the base pan so that its ends are positioned adjacent the ends of the base pan to form a shaped longitudinal cavity in a cake baked in the log pan. The cover member is provided with a curved flange extending away from the periphery of the side wall which is mounted on a flange formed on the ends of the side wall of the base pan. The top of the cover member is provided with a plurality of throughgoing holes to allow steam to escape during the baking process. A support wire assembly is secured to the bottom of the base pan to cradle the base pan and hold the same in an elevated position.

It is an object of the invention to prepare two different composition food products formed as a single dessert.

It is still another object of the invention to provide a dessert assembly which delivers heat energy evenly to all areas of a cake being baked therein.

Yet another object of the invention is to provide a dessert assembly that is easy to use, ruggedized and reliable.

It is a further object of the invention to mold multiple food products made of cake batter or a dessert composition in a desired shape and bake or set the compositions while maintaining heat and pressure at a precise desired level.

It is yet another object of the invention to provide a dessert assembly which is easily broken into individual components and is easy to clean.

Another object of the invention is to provide a dessert assembly which allows the formation of a longitudinal cavity with selectable shaped cross section formed during the baking process in the outer cake to produce a composition uniform cake that is predictable and reproducible without size variance.

Still another object of the invention is to provide a dessert assembly that has one or more of the characteristics discussed above but which is relatively simple to use and requires a minimum of cooking skills.

In the accompanying drawings, there is shown illustrative embodiments of the invention from which these and other objectives, novel features and advantages will be readily apparent.

These and other objects, advantages, and novel features of the present invention will become apparent when considered with the teachings contained in the detailed disclosure along with the accompanying drawings.

### BRIEF DESCRIPTION OF THE DRAWINGS

FIG. 1 is a perspective view of the log pan assembly;

FIG. 2 is an exploded perspective view of the log pan assembly shown in FIG. 1 with the central insert member being removed, the position in the assembly being shown by arrow A;

FIG. 3 is a side elevational view of the log pan assembly shown in FIG. 1;

FIG. 4 is a top plan view of the log pan assembly of FIG. 1;

FIG. 5 is a bottom plan view of the log pan assembly of FIG. 1;

FIG. 6 is an end elevational view of the log pan assembly of FIG. 1;

FIG. 7 is an opposite end elevational view of log pan assembly shown in FIG. 6;

FIG. 8 is a broken away enlarged view of the locking end assembly of FIG. 1;

FIG. 9 is an enlarged cross sectional view of the cover member of the log pan assembly;

FIG. 10 is an enlarged partial cross sectional view of the flange of the base pan having the cover member mounted thereto;

FIG. 11 is an enlarged partial view of the end edge flange of the cover member;

FIG. 12 is a side elevational view of the central section of the cavity producing insert member used in the log pan assembly;

FIG. 13 is an end elevational view of the insert of FIG. 12 taken along lines 13′-13′;

FIG. 14 is a side elevational view of the central section of another embodiment of a cavity producing insert member; and

FIG. 15 is an end elevational view of the insert of FIG. 14 taken along lines 15′-15′.

### DETAILED DESCRIPTION OF THE INVENTION

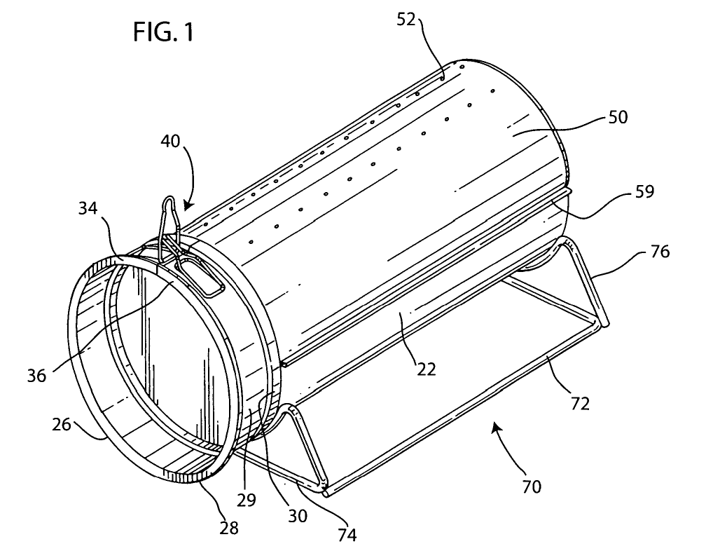

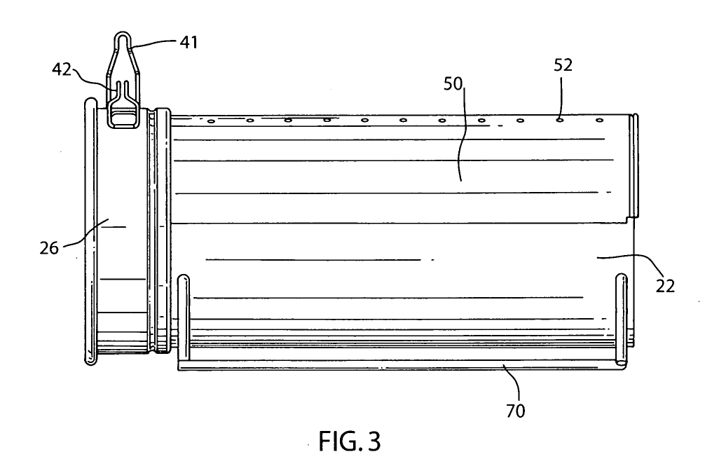

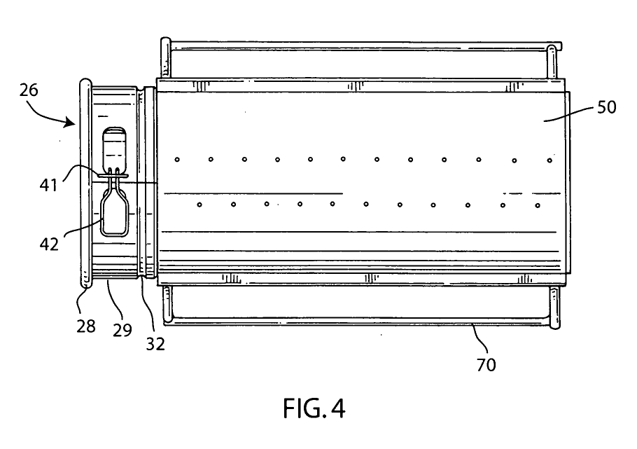

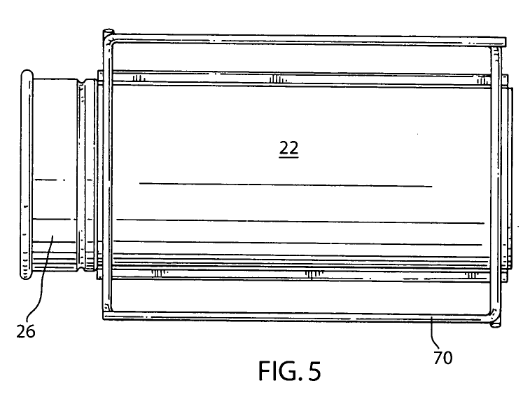

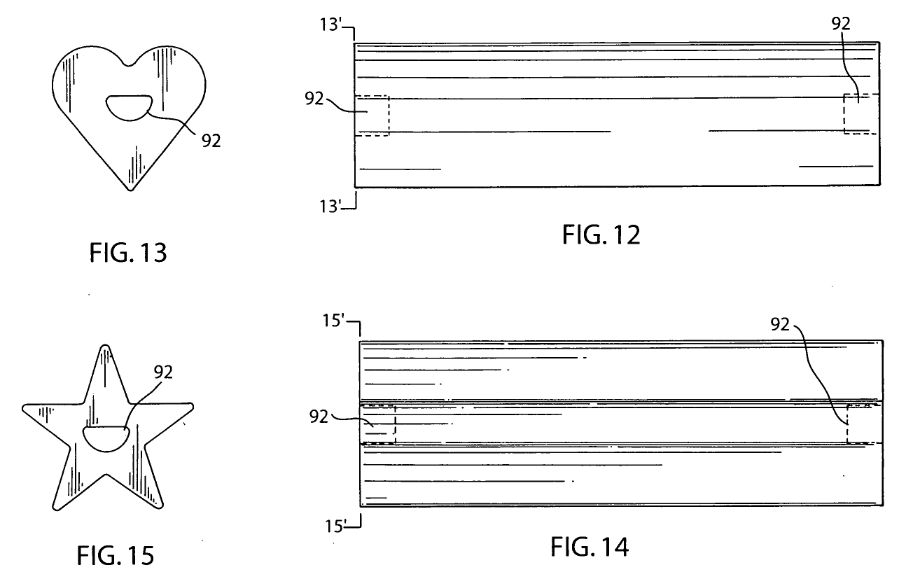

The preferred embodiment and best mode of the invention is shown in FIGS. 1 through 13. The term “batter” as used herein in the application is meant to encompass cake batter, dough, malleable ice cream, gelatin or a malleable dessert which sets up in a rigid or semi-rigid shape.

Referring to the Figures, a log pan assembly 20 according to the invention is adapted to shape or mold batter for a composite cake or other multiple compositions of baked goods or complimentary desserts such as ice cream, gelatins, puddings into a loaf shaped dessert with cylindrical outer surface having a shaped longitudinal cavity.

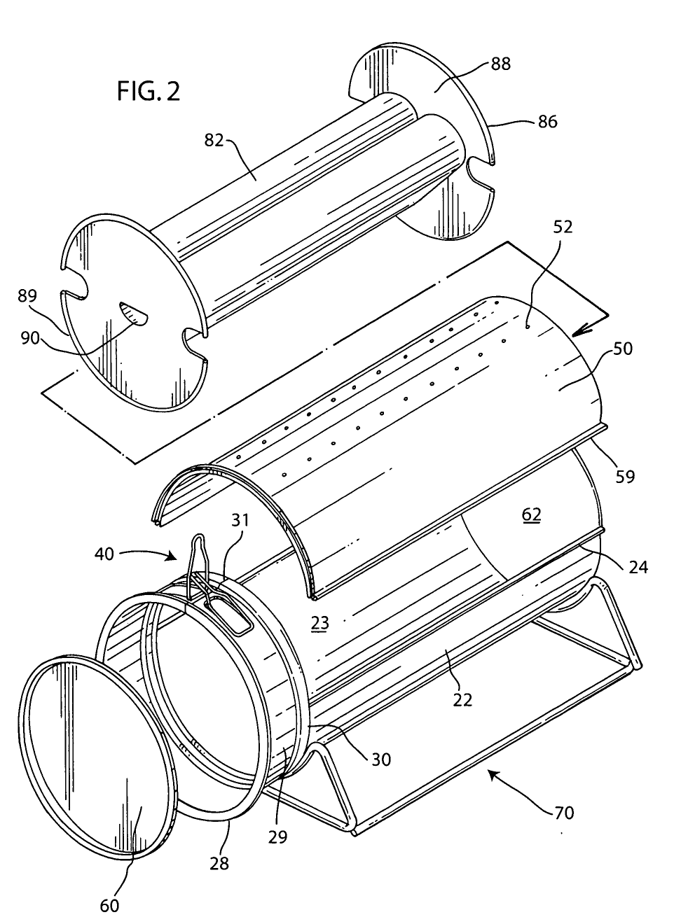

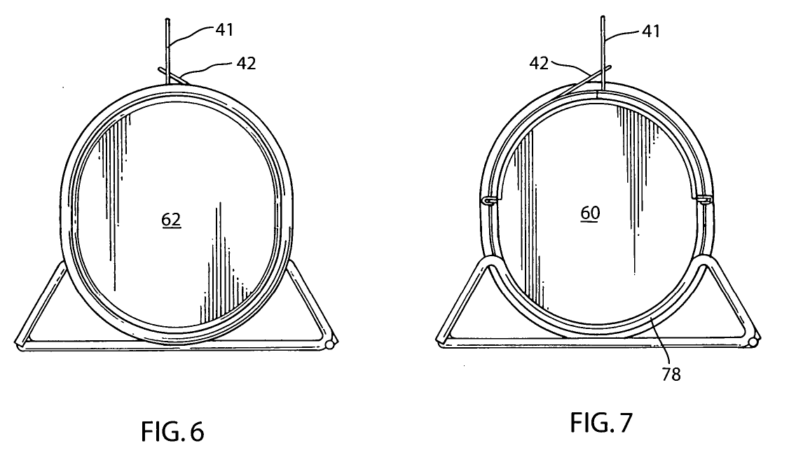

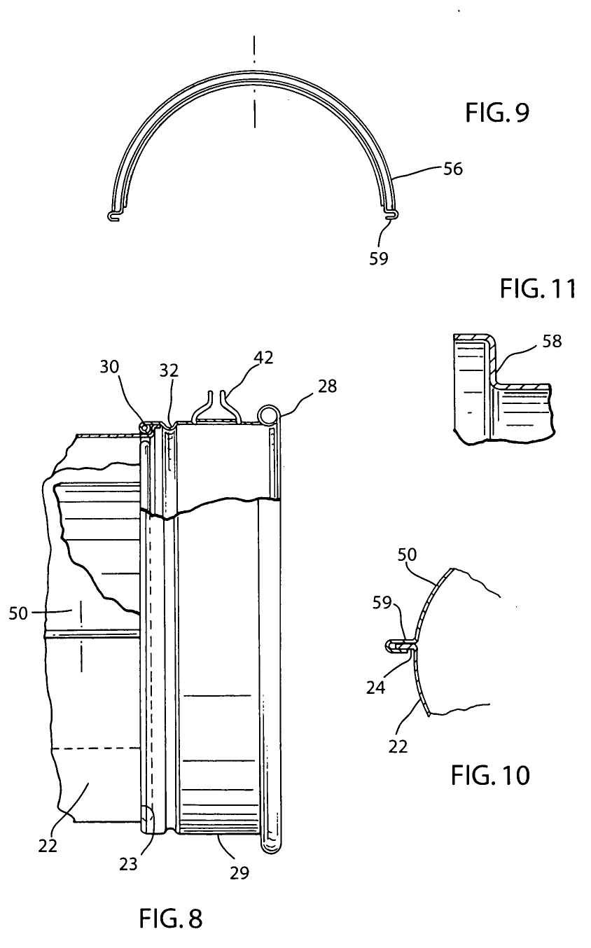

The log pan assembly 20 is constructed with a substantially semi-cylindrical shaped base pan 22, having an outwardly extending side flange 24 and a locking end assembly 26 in the form of a sleeve mounted on one of the base pan 22. The sleeve 26 is shown in FIGS. 2 and 8 and is constructed of two spaced circular ribs 28 and 30 separated by a side wall 29. The sleeve has a transverse cut 31 forming adjacent end surfaces 34 and 36. An inwardly formed channel 32 is located in the proximity of rib 30 and together with rib 30 forms a seat for the L shaped end flange 58 of cover member 50. A standard spring clip assembly 40 is mounted on end surfaces 34 and 36. A rotatable clip member 41 of the clip assembly is mounted on end surface 34 and a companion wire toggle clip member 42 which is connected to the clip member 41 is mounted on end surface 36 to lock the ends 34, 36 of the sleeve together. When clip member 41 is rotated away from the toggle clip member 42 the sleeve ends are closed and when the clip member 41 is rotated toward the toggle clip member 42 the sleeve ends are opened. The locking end sleeve 26 is snap fit over the flange 23 of the base pan 22 and the flange 58 of cover member 50. An enlarged partial view of flanges 23 and 58 is shown in FIG. 11. The upper surface of base 22 is formed with an outward extending flange 24 as shown in FIGS. 2 and 10.

The cover member 50 as seen in FIGS. 1, 2, and 8-10 is mounted on the base pan 22. The cover member 50 is constructed with a generally semi-cylindrical shaped body 54 having side walls 56 which are bent at their ends to form a flanged “C” shaped configuration 59 as seen in FIGS. 9 and 10 to fit over the planar flange 24 of the base pan 22. One end of the cover member 50 is formed with an L-shaped flange 58 which fits over rolled rib 30 of sleeve 26 and abuts sleeve channel 32 holding the cover member 50 in a fixed position in the locking sleeve. A circular planar end member 60 is mounted in the sleeve adjacent channel 32 and flange 58. A second circular planar end member 62 is secured at the other end of the base pan 22.

The cover member 50 is preferably constructed of cold rolled steel has a smooth inner and outer surface and defines a plurality of throughgoing projections 52.

The base pan 22 is mounted on a support member 70 as seen in FIGS. 1 and 5-7. The support member 70 is constructed with a “U” shaped wire base 72 with a proximal end cradle member 74 secured to the open arms of the support member 72 by welding to extend transversely away from the plane of the “U” shaped member 72 and a distal end cradle member 76 secured to the closed end of the “U” shaped member 72 and extending transversely away from the plane of the “U” shaped member 72. Each cradle member 74, 76 is formed with an arcuate trough or cradle 78 which holds the bottom of the cylindrical base pan 22. The base pan 22 is secured to the cradle members 74, 76 by welding or adhesive.

Central cavity forming insert members 80 are mounted in the base pan cavity 23. The insert members 80 are formed with a central longitudinal shaped spacer member 82, a proximal circular end member 84 mounted on the end of the spacer member 82 and a distal circular end member 86 mounted on the other end of the spacer member 82. Each end member has planar sided circular body 88, an outer rim 89, and a substantially semi-cylindrical inwardly projecting hub 90 which engages a similarly configured blind bore 92 formed in the end walls 93 of the longitudinal shaped spacer member 82. The insert member 80 can be provided with a heart shaped cross section configuration 94 as seen in FIG. 13 or a star shaped cross section configuration 96 as seen in FIG. 15. It is apparent that other central cross sections such as a circle, rectangle, triangle, plant, animal or object shape could be used. When the insert member 80 is inserted into cavity 23, its end members 84 and 86 are positioned adjacent the inner surface of end member 60 and 62.

The log base pan 22 and cover member 50 are preferably constructed of sheet steel or stainless steel but can be constructed of copper, aluminum, cast iron, pyrex, glass, porcelain, ceramic or any type of microwaveable material at a uniform desired thickness commonly used for baking pans and containers. If desired, the log pan body can have its external surface coated with a non-corroding material such as tin or chromium. The inside and outside surface of cover member 50, the log base pan 22 and the outside surface of insert member 80 are preferably coated with one or more nonstick coatings, such as for example TEFLON® (i.e., fluorocarbon polymers), (e.g., tetrafluroethlene and fluorinated ethylene propylene) in the preferred embodiment to ease the removal of the baked or chilled product from the bowl. It will be appreciated by those skilled in the art that the specifics of material of which it is made can be changed without departing from scope of the invention. The log base pan 22 and cover 50 can be stamped from a solid piece of material or spun from aluminum instead of formed from a sheet.

As previously noted, the interior surface and outside surface of the each component which contacts the batter or dessert composition is covered with TEFLON® in the preferred embodiment to ease the removal of the baked or chilled product from the bowl. The sloping of the inner wall of the log pan cavity and the cover member cavity further eases removal of the final dessert composition. The end members 84 and 86 are removed from the insert spacer member 82 and the insert member is pulled out from the center of the cake leaving a shaped cavity which can be filled with a separate dessert composition. In operation cake batter is poured into log base pan cavity 23 about ⅔ to ¾ full.

After the batter is molded and baked by the application of heat, the assembly is removed from the oven. The TEFLON® coating of the interior and exterior surface of the log assembly 22 and exterior surface of the central insert member 80 facilitates removal of the mold without tearing or damaging the final baked product located in cavity. The result is a dual composition cake or dessert which is log shaped with a central longitudinal shaped cavity running the length of the log which may be filled with ice cream, pudding, icing or other sweet filling for a dessert pastry.

Although aluminum, sheet steel and/or stainless steel is preferred for the base pan and cover bodies, any suitable structural material, as previously identified, could be used in its place. The inner bowl body has the same material as that of the outer body.

The principles, preferred embodiments and modes of operation of the present invention have been described in the foregoing specification. However; the invention should not be construed as limited to the particular embodiments which have been described above. Instead, the embodiments described here should be regarded as illustrative rather than restrictive. Variations and changes may be made by others without departing from the scope of the present inventions defined by the following claims.

What is claimed is:

1. A cooking pan assembly for forming a log shaped cooking with a central longitudinal cavity in a predetermined shape comprising:
a semi cylindrical base pan with closed ends forming an open cavity, a semi cylindrical cover removably mounted to said base pan and an insert member mounted in said base pan cavity, said insert member having a longitudinal center portion with a cross section which defines a shaped chamber in the formed cooking.

2. A cooking pan assembly as claimed in claim 1 wherein said cooking pan assembly is substantially cylindrical in configuration with planar end walls forming a substantially closed cavity.

3. A cooking pan assembly as claimed in claim 1 wherein said insert member longitudinal portion has a star shaped cross section.

4. A cooking pan assembly as claimed in claim 1 wherein said insert member longitudinal portion has a heart shaped cross section.

5. A cooking pan assembly as claimed in claim 1 wherein at least one surface of said base pan and at least one surface of said cover is coated with a nonstick material.

6. A cooking pan assembly as claimed in claim 5 wherein said nonstick material is tetrafluroethlene.

7. A cooking pan assembly as claimed in claim 5 wherein said nonstick material is fluorinated ethylene propylene.

8. A cooking pan assembly as claimed in claim 1 wherein said base pan has outwardly flanged sidewall ends and said cover member has outwardly flanged sidewall ends which are bent back upon themselves to form a “U” shape to receive and hold said base pan sidewall end flanges.

9. A cooking pan assembly as claimed in claim 1 wherein a mounting rack is secured to said base pan.

10. A cooking pan assembly as claimed in claim 9 wherein said mounting rack comprises a base member and at least two cradle members mounted to said base member.

11. A cooking pan assembly as claimed in claim 10 wherein each cradle member extends transverse to a plane of said base member and defines a circular trough therein to receive said base pan.

12. A cooking pan assembly as claimed in claim 1 wherein one end of said base pan defines a circular locking sleeve assembly, said circular locking sleeve assembly comprising a ring shaped end member defining a lip on each end adapted to be seated over an end of said cover member.

13. A cooking pan assembly as claimed in claim 1 wherein said cover defines a plurality of throughgoing holes.

14. A cooking pan assembly as claimed in claim 12 wherein said circular locking sleeve assembly is a split sleeve and has a locking latch which hold the split sleeve ends together when engaged.

15. A dessert pan assembly for forming a log shaped dessert with a central longitudinal cavity having a predetermined cross sectional configuration along its length comprising:
a semi cylindrical open base pan forming a cavity, a circular split sleeve assembly mounted on one end of cylindrical base pan, a cover removably mounted to said base pan and said circular split sleeve and circular planar surfaced end members mounted on the ends of said base pan, a central insert member mounted in said base pan, said insert member having a longitudinal center portion with a cross section which defines a shaped image and end members mounted on each end of said center portion transverse to the central axis of said longitudinal center portion, said inset member being seated in said semi cylindrical base pan cavity.

16. A dessert pan assembly as claimed in claim 15 wherein a mounting rack is secured to said base pan.

17. A dessert pan assembly as claimed in claim 16 wherein said mounting rack comprises a base member and at least two cradle members mounted transverse to said base member, each cradle member defining a trough structure to hold said base pan.

18. A dessert pan assembly as claimed in claim 15 wherein said insert member has a star shaped cross section.

19. A dessert pan assembly as claimed in claim 15 wherein said insert member has a heart shaped cross section.

20. A dessert pan assembly for forming a log shaped dessert with a central longitudinal cavity having a predetermined cross sectional configuration comprising:
a semi cylindrical open base pan forming a cavity, said base pan having its side wall ends flanged outward to receive a cover member, said cover member being provided with at least a portion of an end wall flanged to be received in a circular sleeve assembly, a circular sleeve assembly mounted to one end of semi cylindrical base pan, a support assembly mounted to said base pan, a cover member removably mounted to said base pan and said circular split sleeve, said cover defining a plurality of throughgoing holes with side wall and ends being formed to be mounted on said base pan side flanges, circular planar end members mounted on each end of said base pan, a central insert member mounted in said base pan, said insert member having a longitudinal center portion with a cross section which defines a shaped image and arcuate end members mounted on each end of said center portion extending transverse to the central axis of said longitudinal center portion, said inset member being seated in said base pan cavity between said circular planar end members.
